(19) United States
(12) Patent Application Publication
(10) Pub. No.: US 2008/0268213 A1
(43) Pub. Date: Oct. 30, 2008

(54) Laminate structure for hot and cold fill food and beverage packaging

(76) Inventor: Harout Ohanesian, Laguna Niguel, CA (US)

Correspondence Address: Myers Dawes Andras & Sherman LLP, Suite 1150, 19900 MacArthur Blvd., Irvine, CA, 92612, US

(21) Appl. No.: 12/148,977

(22) Filed: Apr. 24, 2008

Related U.S. Application Data
(60) Provisional application No. 60/925,929, filed on Apr. 24, 2007.

(51) Int. Cl. B32B 3/00; B32B 33/00; B32B 37/00

(52) U.S. Cl. 428/205; 428/201; 428/354; 156/73.5

(57) ABSTRACT

A heat resistant multi-layer structure configured to form a food or beverage container. The multi-layer structure includes a core layer connected to an external multi-layer side and an internal multi-layer side. The external multi-layer side includes an external multi-layer polymer film and a first bonding layer. The internal multi-layer side includes an internal multi-layer polymer film, a second bonding layer and a barrier layer.

### RELATED APPLICATIONS

This application relates to, claims priority from, and incorporates herein by reference, as if fully set forth, U.S. Provisional Patent Application Ser. No. 60/925,929, filed on Apr. 24, 2007 and entitled “LAMINATE STRUCTURE FOR HOT AND COLD FILL FOOD AND BEVERAGE PACKAGING.”

### BACKGROUND OF THE INVENTION

1. Field of the Invention

The present invention relates generally to composite laminates, and in particular to composite laminate material that is recyclable and has heat resistance characteristics.

2. Background Information

In product packaging today, it is important that materials used for packaging products be recyclable. Many packaging products for liquids and dairy products require the product to first be cooled as the recyclable containers do not withstand filling with hot pasteurized liquids. This adds cost and delays in shipping the products. Some of the costs involved are cooling, storage space required, supervision, etc.

### SUMMARY OF THE INVENTION

One aspect of the invention provides a heat resistant multi-layer structure configured to form a food or beverage container. The multi-layer structure includes a core layer connected to an external multi-layer side and an internal multi-layer side. The external multi-layer side includes an external multi-layer polymer film and a first bonding layer. The internal multi-layer side includes an internal multi-layer polymer film, a second bonding layer and a barrier layer.

Another aspect of the invention provides a laminate structure. The laminate structure comprising: a core layer coupled to a first multi-layer side and a second multi-layer side. The first multi-layer side comprising: a first multi-layer polymer sealable film, a print layer, and a first bonding layer. The second multi-layer side comprising: a second multi-layer polymer sealable film, a second bonding layer, a barrier layer, and a third bonding layer.

Yet another aspect provides a method of forming a recyclable heat resistant multi-layer structure configured for forming food and beverage containers. The method comprising: welding a first side of a core layer to a first multi-layer side and welding a second side of the core layer to a second multi-layer side.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 illustrates a first embodiment of a laminate structure;

FIG. 2 illustrates another embodiment of a laminate structure;

FIG. 3 illustrates yet another embodiment of a laminate structure; and

FIG. 4 illustrates still another embodiment of a laminate structure.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

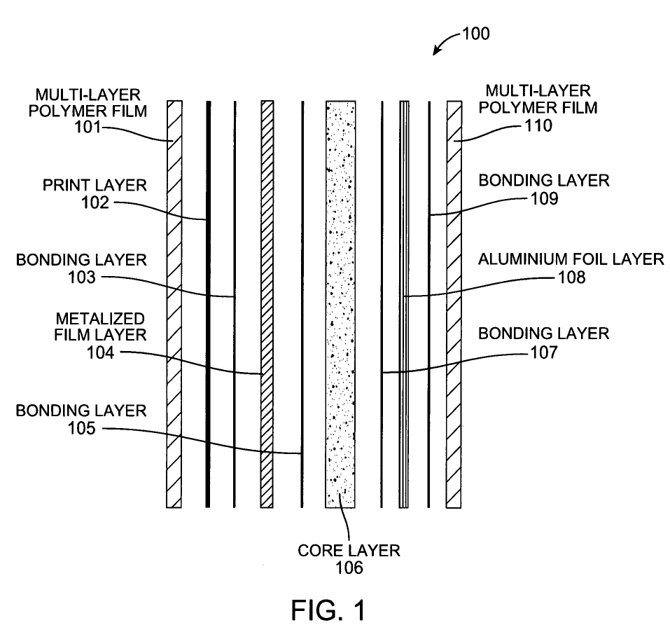

FIG. 1 illustrates a laminate structure according to an embodiment of the invention. The laminate structure 100 is heat resistant and recyclable. The laminate structure 100 is formed into containers for holding food or beverages and can be hot-filled. As illustrated, the laminate structure 100 includes an external outer layer 101 comprising a multi-layer polymer film. In one embodiment of the invention outer layer 101 is extruded either by blown film extrusion or by cast film extrusion. In another embodiment of the invention outer layer 101 is a single layer. In one embodiment of the invention outer layer 101 protects the surface and bonds to an internal layer by use of heat welding at certain portions of the outer layer 101. In one embodiment the outer layer 101 is made of a polyolefin base material and in other embodiments include a polyamide (PA), ethylene vinyl alcohol copolymer (EVOH) or similar materials having high barrier properties that are “sandwiched” in between layers to increase barrier properties. External outer layer 101 forms a clear but anti-contamination barrier and liquid seal, which prevents external material and atmospheric penetration. External outer layer 101 also prevents contamination from penetrating and provides see through functionality.

In one embodiment of the invention, external outer layer 101 is clear. In another embodiment of the invention the laminate structure 100 includes a print layer 102. In one embodiment of the invention the print layer 102 is printed in reverse to protect the printed design from scratches and prevents the ink from coming into contact with food or body parts of users. In this embodiment of the invention, print layer 102 includes a reverse printed label, which can include technical and presentational information in relation to the contents which will be held within a formed container from the laminate material.

In one embodiment, the laminate structure 100 includes a bonding layer 103. In one embodiment the bonding layer 103 is a liquid adhesive coated on a laminating machine. In another embodiment bonding layer 103 is a film layer placed between outer layer 101 and print layer 102 and the metalized layer 104 and or core layer 106 to amalgamate to one another. In one embodiment of the invention, bonding layer 103 secures the print layer 102 and external outer layer 101 on a film layer 104. In one embodiment of the invention, to laminate different layers liquid glue is used to amalgamate the layers. In another embodiment of the invention an adhesive film is used for laminating, and placed between layers and pressed by heat to bond one to the other. In one embodiment of the invention, film layer 104 is a metalized layer. In another embodiment, film layer 104 is a non-metalized film.

In one embodiment of the invention, the laminate structure 100 includes bonding layer 105. In one embodiment of the invention the bonding layer 105 is liquid glue or an adhesive film used to bond 2, 3, 4, etc. layers to one another. In one embodiment of the invention, the lamination method used can be cold, hot, extrusion coating etc. In one embodiment of the invention bonding layer 105 secures film layer 104 on a core layer 106. In this embodiment of the invention, core layer 106 is made of a polymeric compound material inclusive of mineral components. In one embodiment of the invention the core layer 106 is made of a compound comprising different plastic food grade materials compounded with natural food grade minerals and made in extrusion process. Core layer 106 provides the stiffness and rigidity required of the laminate when formed into a food or beverage container. In one embodiment of the invention core 106 forms a heat resistant and skeletal core on which a container shape is based around and which retains its structure and rigidity integrity when exposed to high temperature during hot food or beverage filling. In one embodiment of the invention the compounded material has heat resistance and dead folding characteristics similar to cardboard. The rigidity of the extruded material allows shaping different forms and shapes of containers.

In one embodiment, the internal side of the laminate structure 100 includes a bonding layer 107, which secures the core layer 106 to a barrier layer 108. In one embodiment the barrier layer 108 is made of an aluminum foil layer, which prevents oxygen as well as a UV penetration to preventing penetration of degrading radiation and the minute amounts of Oxygen which may allow retained contents to deteriorate in potable quality. In another embodiment the barrier layer 108 is a polymeric film or coating having similar barrier properties of aluminum foil, namely barring the transmission of both oxygen and UV radiation.

In one embodiment of the invention, the laminate structure 100 further includes a bonding layer 109 that secures the barrier layer 108 to an internal (i.e., to the contents in a container) multi-layer polymer film layer 110. The multi-layer polymer film 110 forms a clear but anti-contamination and liquid impervious seal that forms the final and filled content contact surface. This layer also has seal through contamination properties. In another embodiment, the multi-layer polymer film 110 is colored for additional UV protection of food or beverages.

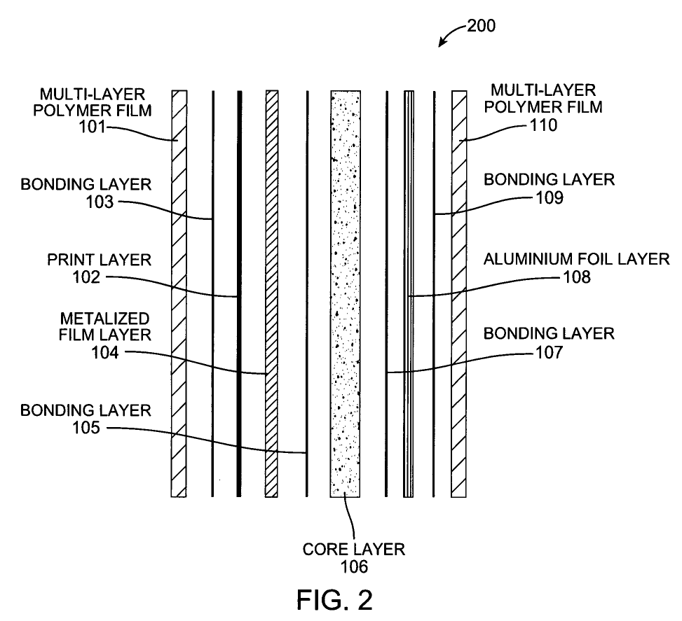

FIG. 2 illustrates another embodiment of a laminate structure 200. In this embodiment of the invention, bonding layer 103 is reversed with print layer 102 as compared with the embodiment illustrated in FIG. 1. In this embodiment of the invention, bonding layer 103 is a bonding agent that secures multi-layer polymer film 101 to the film layer 104. On the external facing surface of the film layer 104 is a print layer 102 which will is printable, for example with technical and presentational information in relation to the contents which will be held within a formed container of laminate structure 200.

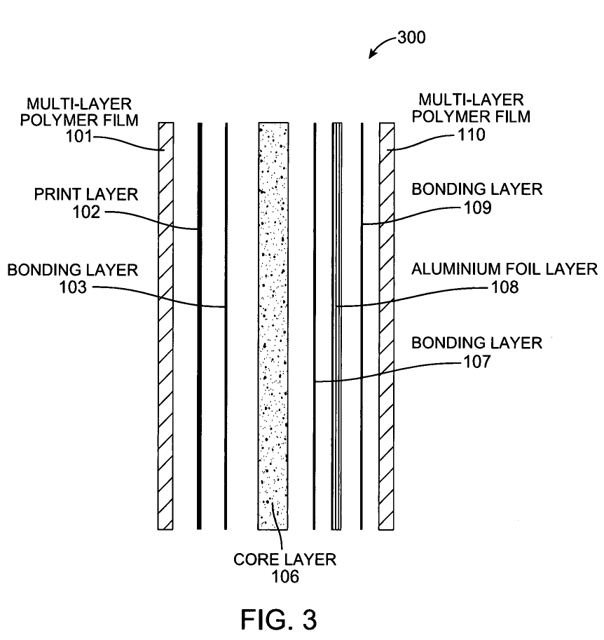

FIG. 3 illustrates another embodiment of a laminate structure 300. In this embodiment, film layer 104 and bonding layer 105 are removed as compared to the embodiment illustrated in FIG. 1.

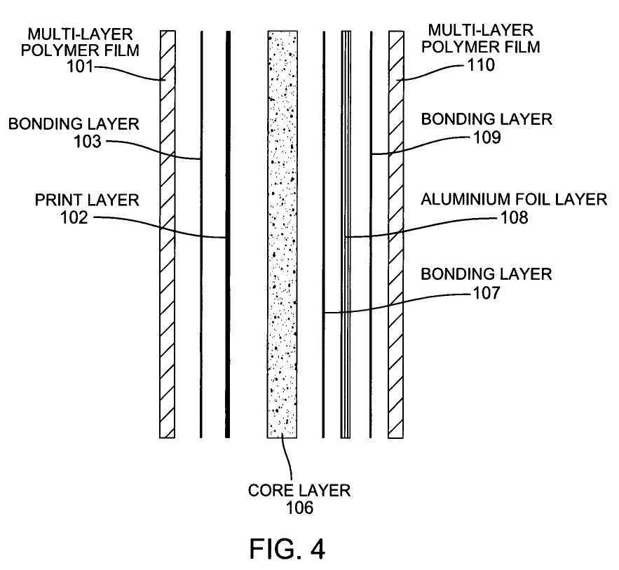

FIG. 4 illustrates yet another embodiment of a laminate structure 400. In this embodiment, print layer 102 and bonding layer 103 are reversed from the embodiment illustrated in FIG. 3.

With the embodiments illustrated in FIGS. 1-4, the total combination of the production materials used within all the laminate layers are mechanically reducible into a regrind format of material that can be recycled and reused in other product configurations. Some of these embodiments include a clear outer barrier for non contact penetration of external materials or environments, that is used as a support layer for printed (e.g., a reverse printed) and protected message. Both the outer and inner multi-layer polymer films (101, 110) have seal through contamination properties. The core layer 106 is made from a polymeric compound material inclusive of mineral components that provides a rigid and stable structure. These embodiments reduce transmission of heat into and through the laminate structures, while preventing UV radiation and Oxygen from penetration. The clear internal sealing barrier forms an enclosure of liquid materials.

Other embodiments of the laminate structure can also exist and retain matching properties to that of the above discussed embodiments. These other embodiments are structured such that the laminate layers can be added to, subtracted from, or base layer materials used in the initial structural layers changed to match either differing external environmental or final content containment criteria.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known structures and techniques have not been shown in detail to avoid obscuring the understanding of this description.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A laminate structure comprising:
a core layer coupled to a first multi-layer side and a second multi-layer side;
the first multi-layer side comprising:
a first multi-layer polymer sealable film;
a print layer; and
a first bonding layer;
the second multi-layer side comprising:
a second multi-layer polymer sealable film;
a second bonding layer;
a barrier layer; and
a third bonding layer.

2. The laminate structure of claim 1, the first multi-layer side further comprising:
a fourth bonding layer; and
a film layer.

3. The laminate structure of claim 2, wherein the film layer is one of a metalized film layer and a non-metalized film layer.

4. The laminate structure of claim 1 or 2, wherein the print layer is disposed between the core layer and the first bonding layer.

5. The laminate structure of claim 1 or 2, wherein the print layer is disposed between the multi-layer film and the first bonding layer.

6. The laminate structure of claim 1, wherein the barrier layer prevents transmission of both oxygen and UV radiation.

7. The laminate structure of claim 6, wherein the barrier layer is made of aluminum.

8. The laminate structure of claim 1, wherein the core layer comprises a polymeric compound material inclusive of mineral components.

9. The laminate structure of claim 1, wherein the laminate structure is impervious to external contaminants in liquid, solid or gaseous forms.

10. The laminate structure of claim 1, wherein the core layer provides an internal rigid and shape forming structure.

11. The laminate structure of claim 1, wherein the laminate structure provides internal heat resistance.

12. The laminate structure of claim 1, wherein the laminate structure configured for hot filling processing.

13. The laminate structure of claim 12, wherein the hot filling processing comprises filling pasteurized food in a container formed of the laminate structure.

14. The laminate structure of claim 1, wherein the first multi-layer polymer sealable film is clear.

15. The laminate structure of claim 1 or 2, wherein the structure provides an internal and external polymeric sheet formed into a container structure with seam welding.

16. The laminate structure of claims 1 or 2, wherein the laminate structure is recyclable.

17. A heat resistant multi-layer structure configured to form a food or beverage container, the multi-layer structure comprising:
a core layer coupled to an external multi-layer side and an internal multi-layer side;
the external multi-layer side comprising:
an external multi-layer polymer film; and
a first bonding layer;
the internal multi-layer side comprising:
an internal multi-layer polymer film;
a second bonding layer; and
a barrier layer.

18. The heat resistant multi-layer structure of claim 17, the external multi-layer side further comprising:
a print layer.

19. The heat resistant multi-layer structure of claim 18, the internal multi-layer side further comprising:
a third bonding layer; and
a barrier layer.

20. The heat resistant multi-layer structure of claim 19, the external multi-layer side further comprising:
a fourth bonding layer; and
a film layer.

21. The heat resistant multi-layer structure of claim 19 or 20, wherein the print layer is viewable through the external multi-layer polymer film.

22. The heat resistant multi-layer structure of claim 19, wherein the barrier layer prevents transmission of both oxygen and UV radiation.

23. The heat resistant multi-layer structure of claim 17, wherein the core layer comprises a polymeric compound material inclusive of mineral components.

24. The heat resistant multi-layer structure of claim 19 or 20, wherein the multi-layer structure is impervious to external contaminants in liquid, solid or gaseous forms.

25. The heat resistant multi-layer structure of claims 19 or 20, wherein the heat resistant multi-layer structure is recyclable.

26. A method of forming a recyclable heat resistant multi-layer structure configured for forming food and beverage containers, the method comprising:
welding a first side of a core layer to a first multi-layer side; and
welding a second side of the core layer to a second multi-layer side.

27. The method of claim 26, the first multi-layer side comprising:
a first multi-layer polymer sealable film;
a print layer; and
a first bonding layer;

28. The method of claim 27, the second multi-layer side comprising:
a second multi-layer polymer sealable film;
a second bonding layer;
a barrier layer; and
a third bonding layer.

29. The method of claim 28, the first multi-layer side comprising:
a fourth bonding layer; and
a film layer.

30. The method of claim 28, wherein the barrier layer prevents transmission of both oxygen and UV radiation.

31. The method of claim 26, wherein the multi-layer structure is formed by lamination.
